(19) United States
(12) Patent Application Publication
(10) Pub. No.: US 2006/0016186 A1
(43) Pub. Date: Jan. 26, 2006

(54) Hydrostatic transmission with bypass valve

(76) Inventors: Xingen Dong, Greeneville, TN (US); Barun Acharya, Johnson City, TN (US); Frank P. Holzschuh, Greeneville, TN (US)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 11/183,331

(22) Filed: Jul. 15, 2005

Related U.S. Application Data
(60) Provisional application No. 60/590,393, filed on Jul. 21, 2004.

(51) Int. Cl. F16D 31/02

(52) U.S. Cl. 60/494

(57) ABSTRACT

A hydrostatic transmission system having a pump and a motor, and a manually controlled bypass valve for creating a short circuit that includes the motor and not the pump, the bypass valve being located closer to the motor than the pump. In a preferred embodiment the bypass passage is located within a housing of a motor of a hydrostatic transmission system and includes a manually controlled valve member that when open and closed respectively permits and blocks flow of fluid between the supply and return line. More particularly, the bypass valve may be integral with the motor of the hydrostatic transmission, and the motor may be a gerotor motor.

### RELATED APPLICATION

This application claims the benefit of U.S. Provisional Application No. 60/590,393 filed Jul. 21, 2004, which is hereby incorporated herein by reference.

### FIELD OF THE INVENTION

The present invention relates generally to hydrostatic transmissions. More particularly, the invention relates to hydrostatic transmissions including bypass valves.

### BACKGROUND OF THE INVENTION

Hydrostatic transmissions have many uses, including the propelling of vehicles, such as mowing machines, and offer a stepless control of the machine's speed. A typical hydrostatic transmission system includes a variable displacement main pump connected in a closed hydraulic circuit with a fixed displacement hydraulic motor. The closed hydraulic circuit includes a first conduit connecting the main pump outlet with the motor inlet and a second conduit connecting the motor outlet with a pump inlet. Either of these conduits may be the high pressure line depending upon the direction of pump displacement from neutral. For most applications, the pump is driven by a prime mover, such as an internal combustion engine or an electrical motor, at a certain speed in a certain direction. Changing the displacement of the pump will change its output flow rate, which controls the speed of the motor. Pump outflow can be reversed, thus reversing the direction of the motor. In a vehicle, the motor is generally connected directly or through suitable gearing to the vehicle's wheels or tracks.

A hydrostatic transmission installed in a vehicle often includes a bypass valve for decoupling the hydraulic motor from the hydraulic pump so that the vehicle can be pushed and/or towed without significant resistance or damage being caused to the hydrostatic transmission. The bypass valve typically connects the pressure lines of the hydrostatic transmission to thereby create a short circuit that bypasses the pump. In the past, the bypass valve was located at the pump as was typical of conventional hydrostatic transmissions used in other applications.

### SUMMARY OF THE INVENTION

The present invention provides a hydrostatic transmission wherein the bypass valve, contrary to conventional practice, is located in closer proximity to the hydraulic motor than to the hydraulic pump. This provides a short circuit thereby minimizing resistance to free rotation of the hydraulic motor. In addition, for vehicle applications such as mowing machines, the bypass valve can be located at a location near the wheel of the vehicle where it can be more easily accessed when needed.

In accordance with one aspect of the invention, a hydrostatic transmission comprises a pump, a motor, a fluid circuit including the pump and motor for the supply of hydraulic fluid to and from the motor for powering the motor, and a manually controlled bypass valve for creating a short circuit that includes the motor and not the pump, wherein the bypass valve is located closer to the motor than the pump thereby minimizing the length of the short circuit.

More particularly, the hydrostatic transmission system for a vehicle comprises a hydraulic pump, a hydraulic motor, first and second lines for supply and return of fluid between the pump and motor, a bypass passage connecting the first and second supply lines, and a manually controlled bypass valve that when open allows fluid to flow through the bypass passage between the first and second lines thereby to provide a short circuit including the motor and not the pump. In accordance with the invention, the bypass valve and passage is located closer to the motor than the pump thereby to minimize the length of the short circuit.

In a preferred embodiment, the bypass passage is located within a housing of the motor and includes a manually controlled valve member that when open and closed respectively permits and blocks flow of fluid between the supply and return lines.

According to another aspect of the invention, a hydraulic motor includes in its housing first and second ports for supply and return of fluid from a pump, a bypass passage connecting the first and second ports, and a manually controlled bypass valve that when open and closed respectively permits and blocks flow of fluid through the bypass passage between the supply and return ports.

The motor may be a gerotor motor and the bypass passage may be located within the confines of the housing. The housing may include a forward end section in which the bypass passage and the inlet and outlet ports are formed. The housing may also include a bore extending from the bypass passage to the exterior of the housing, and the bore may be partially internally threaded while the valve member may have an externally threaded portion thereof engaging the internally threaded bore. Rotation of the valve member axially shifts the valve member between its closed position engaging a valve seat in the bypass passage and its open position spaced from the valve seat.

Further features of the invention will become apparent from the following detailed description when considered in conjunction with the drawings.

### BRIEF DESCRIPTION OF THE DRAWINGS

FIG. 1 is a schematic diagram illustrating a hydraulic circuit of a hydrostatic transmission having a bypass valve in accordance with the present invention.

FIG. 2 is a perspective view of a motor including a bypass valve in accordance with the present invention.

FIG. 3 is a side view of a motor including a bypass valve.

FIG. 4 is a bottom view of a motor including a bypass valve.

FIG. 5 is a cross-sectional view of the bypass valve of the motor of FIG. 4 taken along the line B-B.

### DETAILED DESCRIPTION

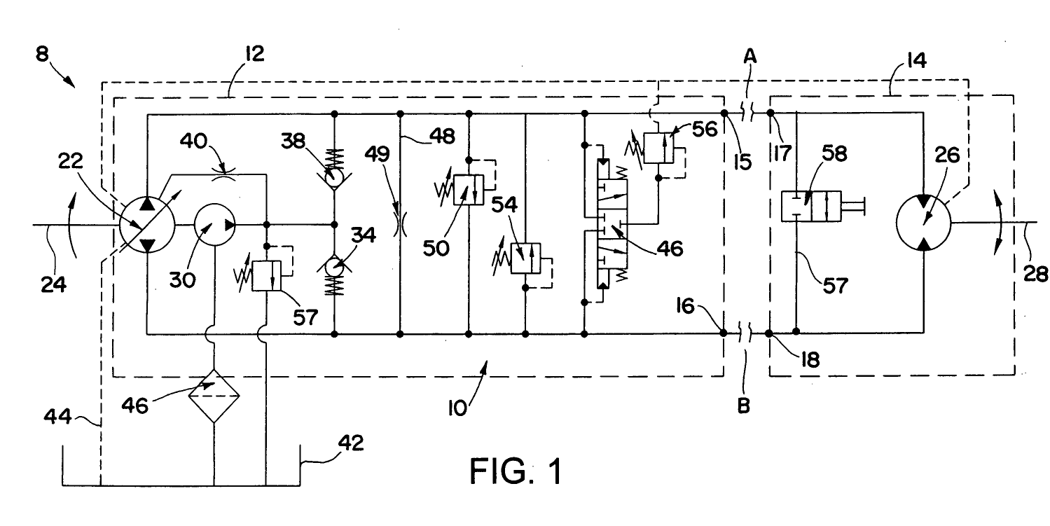

Referring now to the drawings in detail and initially to FIG. 1, an exemplary hydrostatic transmission according to the invention is indicated generally by reference numeral 8. The transmission 8 has a pump/motor fluid circuit 10 including a pump 12 and a motor 14. Pump pressure ports 15 and 16 are connected via pressure lines A and B to motor pressure ports 17 and 18, respectively. The pump 12 includes a pump element 22 driven by an input shaft 24 that in turn is driven by a prime mover (not shown), such as an internal combustion engine. The pump 12 can be a variable flow reversible pump, as shown, or any other suitable pump for supplying high pressure hydraulic fluid via line A or B to the motor 14 for driving a motor element 26, such as a gerotor, connected to an output shaft 28. Depending on the operation state of the reversible pump, high pressure fluid will be supplied to either line A or B while the other line serves as a return line. Thus, as used herein, the term high pressure supply line should be understood to refer to either line A or line B, depending on the direction of flow displacement of the pump 12.

In the illustrated embodiment, the pump 12 includes a charge pump 30 driven by the input shaft 24. The charge pump 30 is typically a positive displacement pump having a smaller capacity than pump 22, preferably about 20%-30% of the capacity of pump 22, for the purpose of providing makeup flow of relatively cool hydraulic fluid from a sump 42 to the pressure lines to account for losses due to leakage in the motor and pump and to provide for continuous exchange of fluid between the pump/motor fluid circuit 10 and the sump to prevent overheating of the hydraulic fluid. To this end, the output of the charge pump 30 is connected to supply lines A and B via check valves 34 and 38. The output of the charge pump 30 is also connected via orifice 40 to the motor element 22 to provide relatively cool hydraulic fluid for cooling the motor element 22. The intake of the charge pump 30 is connected to the sump 42 via a filter 46. A sump drain 44 collects fluid leakage, if present, from both the pump 12 and the motor 14 and directs such leakage to the sump 42. As will be appreciated, the sump drain 44 can be formed by the interior of a housing containing the pump 12 and/or motor 14. The sump drain 44 is also connected to a pressure responsive fluid shuttle valve 47 provided for removing some hot fluid from the pressure return line for fluid exchange purposes, with the charge pump providing relatively cooler makeup fluid to the return line. The pressure responsive fluid shuttle valve 47 is sized to supply a sufficient amount of fluid to the sump 42 such that the charge pump 30 is supplied with enough fluid to operate at or near full capacity. The pressure responsive fluid shuttle valve 47 is pressure responsive and is configured to open the return pressure line to the sump drain 44 when high pressure fluid is being supplied to the other line. The fluid removed from the pressure return line is circulated to the sump 42 via sump drain 44 where it is eventually drawn up by the charge pump 30 and then returned to either supply line A or B as described above.

The sump 42 can be provided with cooling fins or other suitable means for dissipating heat from the fluid as desired. In addition, the sump can be oversized to provide a larger reservoir of cooled oil from which the charge pump 30 can draw fluid.

The pump 12 also includes line 48 that connects pressure lines A and B together via orifice 49. Line 48 and orifice 49 function to allow a predetermined amount of cross flow between pressure lines A and B. The cross-flow provided by line 48 and orifice 49 broadens the neutral range of the hydrostatic transmission and provides smoother starting and stopping of the motor 14 when the pump 12 is operated. A pair of high pressure relief valves 50 and 54 is also provided for protecting the hydraulic circuit 10 from overloading during operation. The relief valves 50 and 54 operate to relieve pressure from the high pressure supply line to the pressure return line when an overload condition exists, such as when the pump 22 is being driven by the prime mover but the motor output shaft 28 is prevented from rotating. Pressure relief valves 56 and 57 are also included at the outlet of the shuttle valve 46 and in parallel with the charge pump 30 to ensure that the hydraulic system 10 does not overload. Pressure relief valve 56 further operates to ensure a minimum pressure in the pressure return line to prevent the pump 12 from running dry under low load conditions.

A bypass passage 57 is connected across the pressure lines A and B to provide a short circuit across the inlet and outlet of the motor 14. The bypass passage 57 includes a manually controlled bypass valve 58 which, when open, creates a short circuit that permits flow between pressure lines A and B and through the motor element 26 without passage through the pump 12. The bypass valve 58 may be opened to permit free rotation of the motor output shaft 28 as may be desired when the vehicle is being towed or pushed.

In accordance with the invention, the bypass passage 57 and valve 58 are provided at a location closer to the motor 14 than the pump 12, thereby to minimize the length of the short circuit. The bypass passage 57 and valve 58 preferably are provided adjacent or within the motor 14 as shown and further described below.

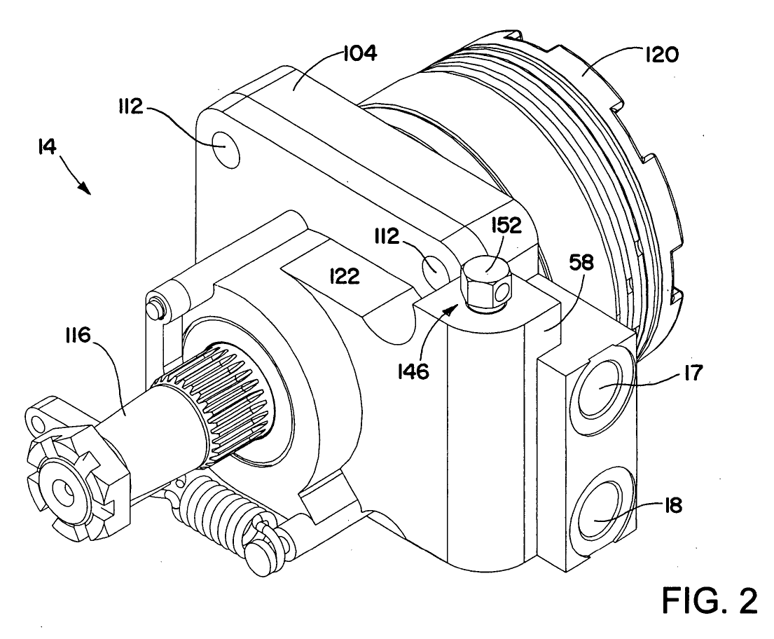

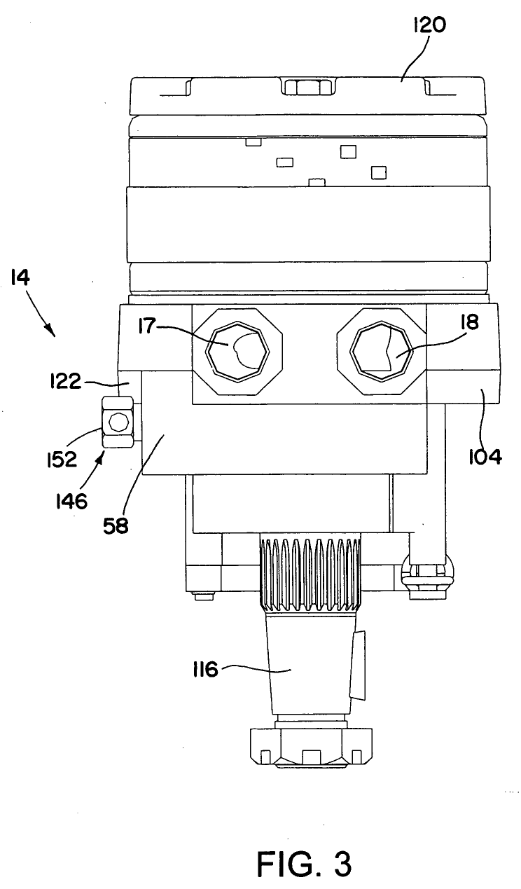

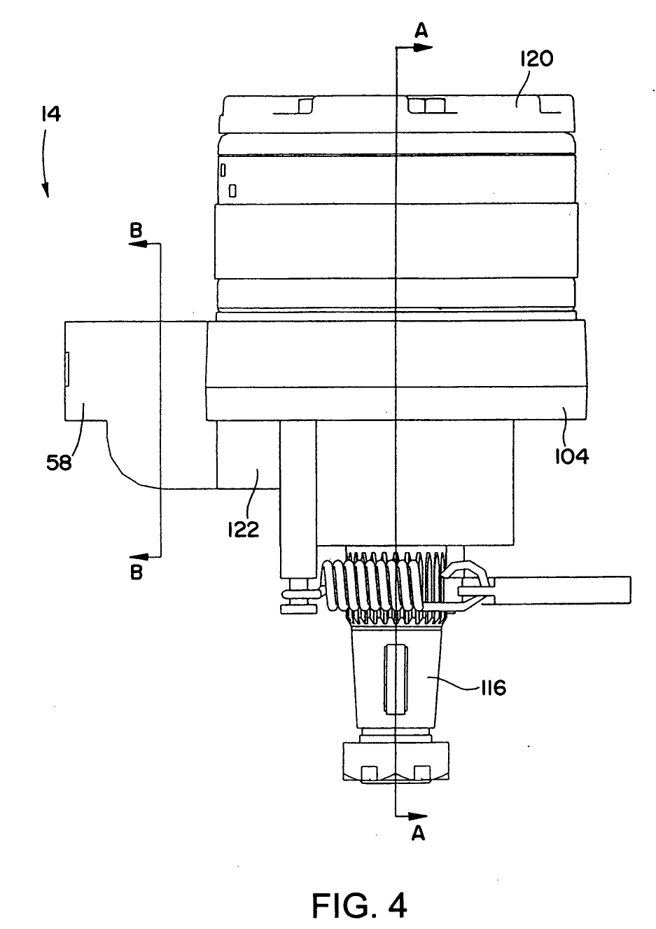

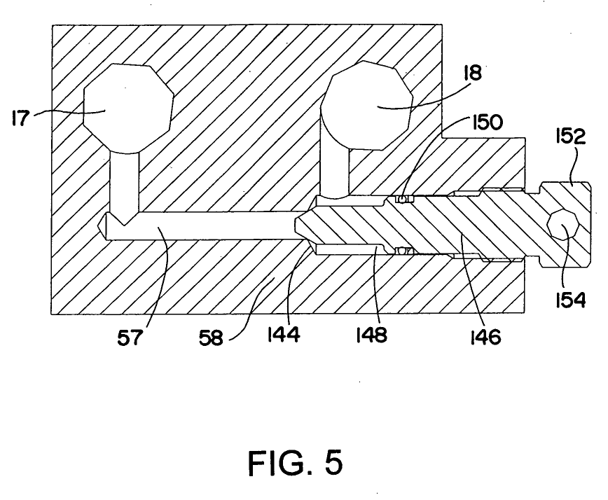

Turning now to FIGS. 2-5, the hydraulic motor 14 includes a housing 104 provided in a flange portion thereof with mounting holes 112 through which bolts can extend to secure the motor, for example, to the frame of a vehicle. Extending from one side of the housing 104 is an output shaft 116 that can be coupled to a wheel of the vehicle. The output shaft 116, in conventional manner, is connected to the moving motor element, such as a gerotor, which is contained within a back side 120 of the housing 104. Suitable porting is provided for coupling the moving motor element to pressure ports 17 and 18 that provide for connection of the motor to pressure lines A and B (FIG. 1) for supply and return of fluid.

The housing 104 further includes the bypass passage 57 and valve 58. The bypass passage 57 and valve 58 are located in a forward end section 122 of the housing that also contains the inlet/outlet pressure ports 17 and 18. The bypass valve 58 includes a valve seat 144 in the bypass passage 57 and a manually controlled valve member 146. The valve member 146 is threaded into a threaded bore 148 that extends from the bypass passage 57 to the exterior of the housing 104. Suitable means, such as O-ring 150, may be provided to seal the valve member 146 to the housing 104.

The valve member 146 preferably has an end portion 152 projecting outwardly of the housing 104 that is provided with means for facilitating rotation of the valve member 146. For example, the valve member 146 may be provided with a hex head for turning of the valve member 146 with the aid of a wrench. The head may also or alternatively be provided with a transverse bore 154 through which a tool, such as a screwdriver, can be inserted for turning of the valve member.

As will be appreciated, the valve member 146 can be rotated to move the sealing end thereof into engagement with the valve seat 144 to close the valve 58 and block flow of fluid through the bypass passage 57. When it is desired to shunt flow across the motor 14, the valve member 146 can be rotated in the reverse direction to open the valve 58.

As mentioned, the manually controlled bypass valve 58 when open and closed respectively permits and blocks flow of fluid through the bypass passage between the supply and return pressure ports 124 and 128. Other manually controlled valves besides the above-described valve 58 can also be used in accordance with the invention. For example, the bypass valve 58 can be a solenoid actuated bypass valve having a manually operated control assembly for manually operating the solenoid.

In view of the foregoing, it will now be appreciated that when the hydraulic motor of the hydrostatic transmission is directly coupled with a wheel of a vehicle, such as a lawn mower, the bypass valve generally can be located so that it is easily accessible from the wheel well of the vehicle. Thus, the present invention facilitates placement of the bypass valve in a location that is generally more convenient to access than prior art designs.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hydrostatic transmission system for a vehicle, comprising a hydraulic pump, a hydraulic motor, first and second lines for supply and return of fluid between the pump and motor, a bypass passage connecting the first and second supply lines, and a manually controlled bypass valve that when open allows fluid to flow through the bypass passage between the first and second lines thereby to provide a short circuit including the motor and not the pump, wherein the bypass valve is located closer to the motor than the pump thereby to minimize the length of the short circuit.

2. A hydrostatic transmission system as set forth in claim 1, wherein the bypass valve is adjacent the motor.

3. A hydrostatic transmission system as set forth in claim 1, wherein the bypass valve is integral with the motor.

4. A hydrostatic transmission system as set forth in claim 3, wherein the motor is a gerotor motor.

5. A hydrostatic transmission system as set forth in claim 1, wherein the bypass passage is located within a housing of the motor.

6. A hydrostatic transmission system as set forth in claim 1, wherein the bypass valve includes a manually controlled valve member that when open and closed respectively permits and blocks flow of fluid between the supply and return line.

7. A hydraulic motor including first and second ports for supply and return of fluid from a pump, a bypass passage connecting the first and second ports, and a manually controlled bypass valve that when open and closed respectively permits and blocks flow of fluid through the bypass passage between the supply and return ports.

8. A hydrostatic transmission system as set forth in claim 7, wherein the motor is a gerotor motor.

9. A hydrostatic transmission system as set forth in claim 7, wherein the motor includes a motor housing including the inlet and outlet ports, and the bypass passage is located within the confines of the housing.

10. A hydrostatic transmission system as set forth in claim 9, wherein the housing includes a forward end section in which the bypass passage and the inlet and outlet ports are formed.

11. A hydrostatic transmission system as set forth in claim 9, wherein the housing includes a bore extending from the bypass passage to the exterior of the housing, and the bore is partially internally threaded, and the valve member has an externally threaded portion thereof engaging the internally threaded bore, whereby rotation of the valve member will axially shift the valve member between its closed position engaging a valve seat in the bypass passage and its open position spaced from the valve seat.

12. A hydrostatic transmission system including a hydraulic pump and the hydraulic motor as set forth in claim 7.
